(19) United States
(12) Patent Application Publication
(10) Pub. No.: US 2010/0043945 A1
(43) Pub. Date: Feb. 25, 2010

(54) LOW-TEMPERATURE ADHESIVE UNDERCOAT COMPOSITION

(75) Inventors: Reto Dohner, Zurich (CH); Wolf-Rudiger Huck, Zurich (CH)

Correspondence Address: OLIFF & BERRIDGE, PLC, P.O. BOX 320850, ALEXANDRIA, VA, 22320-4850, US

(73) Assignee: Sika Technology AG, Baar (CH)

(21) Appl. No.: 12/312,590

(22) PCT Filed: Nov. 20, 2007
(86) PCT No.: PCT/EP2007/062569

§ 371 Date: Sep. 23, 2009

(30) Foreign Application Priority Data
Nov. 20, 2006 (EP) 06124398.6

(51) Int. Cl. B32B 43/00; B05D 5/10; B32B 37/12; B32B 7/12

(52) U.S. Cl. 156/98; 427/207.1; 156/310; 156/60; 428/354

(57) ABSTRACT

A method for producing an adhesive undercoat on a substrate S1 with a substrate temperature of lower than 5° C. The adhesive undercoat composition comprises at least one mercaptosilane MS or an adduct of mercaptosilane and either at least one polysilane PSA, comprising at least one secondary or tertiary amino group, or at least one polysilane PS and at least one aminosilane AS, comprising at least one secondary or tertiary amino group. This method is particularly suited for the gluing of glass, particularly of glass ceramics, preferably for repairing windows of motor vehicles in cold temperatures.

### TECHNICAL FIELD

The present invention relates to the field of adhesive undercoat compositions, and to the uses thereof.

### STATE OF THE ART

Adhesive undercoat compositions are known. Such compositions are used in order to enable, or to improve, the adhesion of a coating or of an adhesive or sealant to various substrates.

A large number of adhesive undercoat compositions have been developed in order to improve adhesion to glass, especially to glass ceramic, and to paint. These substrates are important especially because they are present in the adhesive bonding of panes in modes of transport, especially in automobiles, and because this adhesive bond constitutes a very important adhesive application.

WO 2005/059056 A1 describes clear primers which comprise titanate, mercaptosilane, polyaminosilane, secondary aminosilanes and solvent, and which lead to improved adhesive bonding of polyurethane adhesives to glass.

The adhesive bonds are typically produced at an ambient temperature of about 23° C. When cold substrates, i.e. colder than 5° C., are to be adhesive bonded, they are typically warmed under controlled conditions to about 23° C. before being adhesive bonded, i.e. before the adhesive undercoat is applied. However, this is very inconvenient, takes time and costs money. For example, a vehicle in which a pane has to be replaced in winter has to be transported to a heated garage. In rural areas, however, this in many cases involves transport over long distances. Furthermore, the pane can be transported to the vehicle prepared with the primer applied in the garage. For this purpose, however, good adhesion of the adhesive to the cold surface of the vehicle substrate or of the primer applied thereto, and a long open time of the primer is necessary, which firstly causes great risks of inadequate adhesion and/or severe restrictions in flexibility. Moreover, there is the great problem that the primer applied beforehand might become contaminated before the contact with the adhesive and accordingly has to be packaged specially with additional labor.

There have therefore been efforts for some time to be able to perform such adhesive bonding operations in winter on the street. However, it has been found that, in these cases where cold substrates have been adhesive bonded, especially at substrate temperatures below 5° C., in particular of less than 0° C. or even less than −5° C., greatly worsened adhesion occurs even with utilization of adhesive undercoat compositions.

### SUMMARY OF THE INVENTION

It is therefore an object of the present invention to provide adhesive undercoat compositions which lead good adhesion promotion, especially on glass and glass ceramic, even at low temperatures, i.e. at substrate temperatures of less than 5° C., especially of less than 0° C.

It has now been found that, surprisingly, specific adhesive undercoat compositions as described by claim 1 can be used for this purpose in order to be able to achieve the stated object.

In addition to good adhesive bonding at room temperature, greatly improved adhesion both to glass and glass ceramics was found for these adhesive undercoat compositions at temperatures below 5° C., especially between 0° C. and −10° C., preferably between −5° C. and −15° C.

This allows performance, at cold ambient temperatures as frequently occur in winter, especially of pane repairs also outside temperature-controlled rooms, for example on the street, without any need to heat the bonding area, as, for example, by means of mobile thermal radiators or electrical heaters. For reasons of better handling and cost, this is a particularly great advantage.

In a further aspect, the invention relates to a process for producing a substrate coated with adhesion promoter undercoat composition as claimed in claim 16, and to a process for adhesive bonding of two substrates as claimed in claim 17, and the article resulting therefrom as claimed in claim 22. In a further aspect, the invention finally relates to a process for repairing glazing of a mode of transport as claimed in claim 24.

Further particularly preferred embodiments of the invention are the subject matter of the dependent claims.

### WAYS OF PERFORMING THE INVENTION

The present invention relates, in a first aspect, to the use of an adhesive undercoat composition for producing an adhesive undercoat on a substrate S1 at a substrate temperature of less than 5° C., especially between 0° C. and −20° C., preferably between −5° C. and −15° C.

The adhesive undercoat composition comprises
at least one mercaptosilane MS or an adduct of a mercaptosilane MS,
and
either at least one polysilane PSA which has at least one secondary or tertiary amino group,
or
   at least one polysilane PS and at least one aminosilane AS which has at least one secondary or tertiary amino group.

In the present document, a “silane group” is understood to mean an —SiX_{y}R_{(3-y)} group which is bonded to an organic radical via a silicon atom and has at least one (y=1) to three (y=3) hydrolyzable radicals or OH(X), and which optionally also has one (y=2) or two (y=1) alkyl R groups having 1 to 4 carbon atoms. The hydrolysis of the silane group, for example as a result of contact with air humidity, forms silanol groups (Si—OH groups), and subsequent condensation reactions of the silanol groups form siloxane groups (Si—O—Si groups). A “hydrolyzable radical” is understood to mean those radicals on a silane group which are displaced from the silicon atom intact in a hydrolysis reaction by water and are formally replaced there by a hydroxyl group. The hydrolysis reaction protonates the hydrolyzable radical to give a low molecular weight compound which may be organic or inorganic.

In the present document, “silane” is understood to mean an organosilicon compound which has at least one silane group, more particularly one which has at least one hydroxyl group, alkoxy group or acyloxy group bonded to a silicon atom, and at least one organic substituent bonded to a silicon atom via a carbon-silicon bond.

In the present document, “polysilane” is understood to mean a silane which has two or more silane groups in the same molecule.

Silanes which have amino, mercapto or oxirane groups in the organic radical bonded to the silicon atom of the silane group are referred to as, respectively, “aminosilanes”, “mercaptosilanes” and “epoxysilanes”. A secondary aminosilane has a secondary amino group —NH—. A primary aminosilane has a primary amino group —NH₂. A tertiary aminosilane has a tertiary amino group

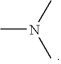

Substance names beginning with “poly”, such as polyol, polyisocyanate, polymercaptan or polyamine, denote, in the present document, substances which contain, in a formal sense, two or more of the functional groups which occur in their name per molecule.

In the present document, an adduct of a mercaptosilane MS is understood to mean the reaction product of a mercaptosilane with an epoxide, polyepoxide or polyisocyanate, in which the mercapto group reacts with an epoxy group or isocyanate group.

It is essential for the present invention that a secondary or tertiary amino group in a silane and a polysilane, i.e. a compound with a plurality of silane groups, are present simultaneously. In the first embodiment, the polysilane is a polysilane PSA which has at least one secondary or tertiary amino group, i.e. the features essential to the invention of the polysilane and of the secondary or tertiary aminosilane are realized in the same molecule.

In the second embodiment, the features of polysilane and secondary or tertiary aminosilane are realized by two different molecules, specifically the polysilane PS and the aminosilane AS which has at least one secondary or tertiary amino group.

A suitable polysilane PSA which has at least one secondary or tertiary amino group is especially aminosilane of the formula (I)

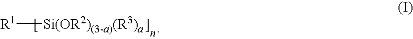

In this structure, R¹ is an n-valent organic radical having at least one secondary or tertiary amino group. R² is independently hydrogen or an alkyl group having 1 to 4 carbon atoms or an acyl group. In addition, R³ is independently H or an alkyl group having 1 to 10 carbon atoms, and n is 2, 3 or 4. More preferably n is 2 or three, i.e. the polysilane PSA preferably has two or three silane groups. Preference is given to polysilanes PSA with two silane groups.

Polysilanes PSA where a=0 are preferred. Preferably R² is methyl, ethyl, propyl, butyl and the positional isomers thereof. R² is most preferably methyl.

In one embodiment, preferred polysilanes PSA which have at least one secondary or tertiary amino group are aminosilanes of the formula (II).

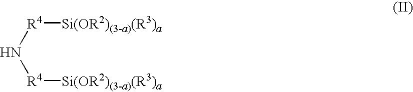

In this structure, R⁴ is a linear or branched alkylene group having 1 to 6 carbon atoms, especially propylene.

Particularly preferred polysilanes PSA include bis(3-trimethoxysilylpropyl)amine and bis(3-triethoxysilylpropyl)amine. The most preferred polysilane PSA in this embodiment is bis(3-trimethoxysilylpropyl)amine.

In a further embodiment, preferred polysilanes PSA which have at least one secondary or tertiary amino group are aminosilanes which have at least one structural element of the formula (III) or (III′), especially of the formula (III″) or (III′″).

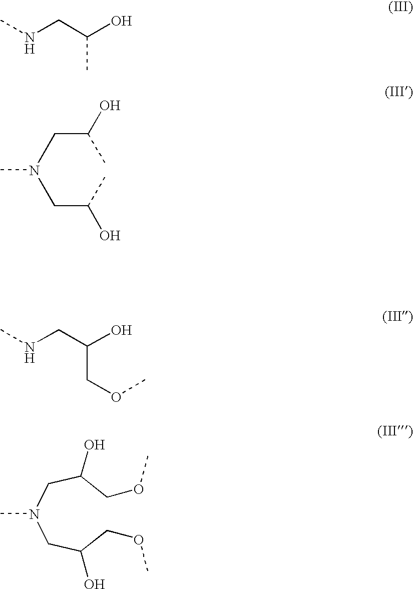

Such polysilanes PSA can be prepared via reactions of primary or secondary amines with glycidyl ethers. The silane groups may originate even from the amine or from the glycidyl ether.

Such reaction products are firstly, for example, the reaction products of 3-aminopropyltrimethoxysilane or bis(3-trimethoxysilylpropyl)amine, and bisphenol A diglycidyl ether or hexanediol diglycidyl ether.

Examples of such polysilanes PSA which have at least one secondary or tertiary amino group are, on the other hand, reaction products of an epoxysilane of the formula (IV) with an aminosilane of the formula (IV′).

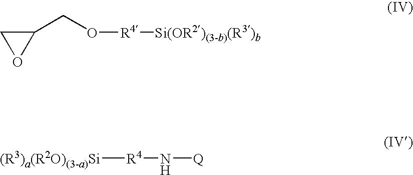

In these structures, R^{2′} is independently hydrogen or an alkyl group having 1 to 4 carbon atoms or an acyl group an alkyl group having 1 to 4 carbon atoms. Preferably, R^{2′} is methyl. R^{3′} is independently H or an alkyl group having 1 to 10 carbon atoms. R⁴ and R^{4′} are each independently a linear or branched alkylene group having 1 to 6 carbon atoms, especially propylene. Q is H, a C₁-C₂₀-alkyl, cycloalkyl or aryl radical, or a radical of the formula —(CH₂—CH₂—NH)_{d}H or a radical of the formula —R⁴—Si(OR²)₍₃₋ₐ₎(R³)ₐ. The indices b and d are each 0, 1 or 2, preferably 0. R³, R² and a are each defined as already described for formula (I).

Such reaction products may have a structure of the formula (IV″).

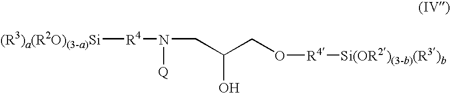

Particularly preferred polysilanes PSA which have at least one secondary or tertiary amino group are reaction products of 3-aminopropyltrimethoxysilane or bis(3-trimethoxysilylpropyl)amine and 3-glycidyloxypropyltrimethoxysilane.

The proportion of the polysilane PSA which has at least one secondary or tertiary amino group is advantageously 0.5-30% by weight, especially 1-15% by weight, preferably 1-10% by weight, based on the weight of the adhesive undercoat composition.

Suitable polysilanes PS are firstly especially polysilanes which can be obtained from the reaction of an aminosilane or mercaptosilane with a polyisocyanate or with a polyurethane prepolymer having isocyanate groups. Such polysilanes PS have especially the formula (IX)

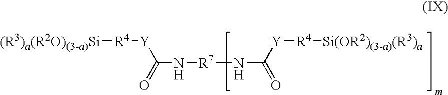

In this formula, Y is NH, NR⁸ or S, where R⁸ is an alkyl or aryl group, especially having 1 to 10 carbon atoms, or a radical of the formula —R⁴—Si(OR²)₍₃₋ₐ₎(R³)ₐ. In addition, R⁷ is a polyisocyanate or polyurethane prepolymer having isocyanate groups after removal of all NCO groups, and m is 1, 2 or 3, especially 1 or 2.

Suitable aminosilanes are especially aminosilanes with primary amino groups, for example 3-aminopropyltrimethoxysilane, 3-aminopropyldimethoxymethylsilane, 3-amino-2-methylpropyltrimethoxysilane, 4-aminobutyltrimethoxysilane, 4-aminobutyldimethoxymethylsilane, 4-amino-3-methylbutyltrimethoxysilane, 4-amino-3,3-dimethylbutyltrimethoxysilane, 4-amino-3,3-dimethylbutyldimethoxymethylsilane, 2-aminoethyltrimethoxysilane, 2-aminoethyldimethoxymethylsilane, aminomethyltrimethoxysilane, aminomethyldimethoxymethylsilane or aminomethylmethoxydimethylsilane. Preference is given to 3-aminopropyltrimethoxysilane and 3-aminopropylmethyldimethoxysilane.

Even though they are slower to react, the aminosilanes used may also be aminosilanes with secondary amino groups, for example N-butyl-3-aminopropyltrimethoxysilane, N-methyl-3-aminopropyltrimethoxysilane, N-phenyl-3-aminopropyltrimethoxysilane or bis(3-trimethoxysilylpropyl)amine.

Secondary aminosilanes are preferred over primary aminosilanes since they possess better solubility of the polysilanes PS formed and precipitate to a lesser degree.

Suitable mercaptosilanes are especially the mercaptosilanes MS mentioned below.

Suitable polyisocyanates are especially diisocyanates or triisocyanates. Preference is given to commercially available polyisocyanates, for example hexamethylene 1,6-diisocyanate (HDI), 2-methylpentamethylene 1,5-diisocyanate, 2,2,4- and 2,4,4-trimethylhexamethylene 1,6-diisocyanate (TMDI), dodecamethylene 1,12-diisocyanate, lysine diisocyanate and lysine ester diisocyanate, cyclohexane 1,3- and 1,4-diisocyanate and any desired mixtures of these isomers, 1-isocyanato-3,3,5-trimethyl-5-isocyanatomethylcyclohexane (=isophorone diisocyanate or IPDI), perhydro diphenylmethane 2,4′- and 4,4′-diisocyanate (HMDI), 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethylxylylene 1,3- and 1,4-diisocyanate (m- and p-TMXDI), bis(1-isocyanato-1-methylethyl)naphthalene, tolylene 2,4- and 2,6-diisocyanate and any desired mixtures of these isomers (TDI), diphenylmethane 4,4′-, 2,4′- and 2,2′-diisocyanate and any desired mixtures of these isomers (MDI), phenylene 1,3- and 1,4-diisocyanate, 2,3,5,6-tetramethyl-1,4-diisocyanatobenzene, naphthalene 1,5-diisocyanate (NDI), 3,3′-dimethyl-4,4′-diisocyanatodiphenyl (TODI), and any desired mixtures of the aforementioned isocyanates and the biurets thereof or the isocyanurates thereof. Particular preference is given to MDI, TDI, HDI and IPDI, and the biurets or isocyanurates thereof.

Polyurethane prepolymers having isocyanate groups can be obtained especially from the polyisocyanates just mentioned and the polyols and/or polyamines mentioned further down in a known manner.

Suitable polysilanes PS are, on the other hand, addition products of isocyanatosilanes with polyols or polyamines or polymercaptans. Such polysilanes PS have especially the formula (X) or (X′)

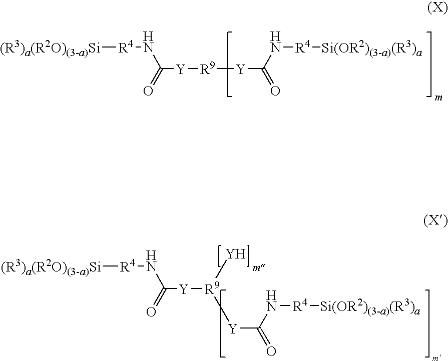

In these formulae, Y is NH, NR⁸ or S, where R⁸ is an alkyl or aryl group, especially having 1 to 10 carbon atoms. In addition, R⁹ is a polyamine or polymercaptan after removal of all NCO groups and m is 1, 2 or 3, especially 1 or 2, and m′>0 and m″>0, with the condition that the sum of m′ and m″ is 1, 2 or 3, especially 1 or 2. The polysilane PS of the formula (X′) thus has free YH groups, i.e. the polyol or polyamine or polymercaptan has not been reacted fully with the NCO groups.

Suitable isocyanatosilanes are especially 3-isocyanatopropyltrimethoxysilane and 3-isocyanatopropylmethyldimethoxysilane.

Suitable polyamines are especially aliphatic polyamines such as ethylenediamine, 1,2- and 1,3-propanediamine, 2-methyl-1,2-propanediamine, 2,2-dimethyl-1,3-propanediamine, 1,3- and 1,4-butanediamine, 1,3- and 1,5-pentanediamine, 1,6-hexanediamine, 2,2,4- and 2,4,4-trimethylhexa-methylenediamine and mixtures thereof, 1,7-heptanediamine, 1,8-octanediamine, 4-iminomethyl-1,8-octanediamine, 1,9-nonanediamine, 1,10-decanediamine, 1,11-undecanediamine, 1,12-dodecanediamine, methylbis(3-aminopropyl)amine, 1,5-diamino-2-methylpentane (MPMD), 1,3-diamino-pentane (DAMP), 2,5-dimethyl-1,6-hexamethylenediamine, cycloaliphatic polyamines such as 1,3- and 1,4-diaminocyclohexane, bis(4-aminocyclohexyl)-methane, bis(4-amino-3-methylcyclohexyl)methane, bis-(4-amino-3-ethyl-cyclohexyl)methane, bis(4-amino-3,5-dimethylcyclohexyl)methane, 1-amino-3-aminomethyl-3,5,5-trimethylcyclohexane (=isophoronediamine or IPDA), 2- and 4-methyl-1,3-diaminocyclohexane and mixtures thereof, 1,3- and 1,4-bis(aminomethyl)cyclohexane, 1-cyclohexylamino-3-aminopropane, 2,5(2,6)-bis(aminomethyl)bicyclo[2.2.1]heptane (NBDA, produced by Mitsui Chemicals), 3(4),8(9)-bis(aminomethyl)tricyclo[5.2.1.0^{2,6}]decane, 3,9-bis(3-aminopropyl)-2,4,8,10-tetraoxaspiro[5.5]undecane, 1,3- and 1,4-xylylenediamine, aliphatic polyamines containing ether groups, such as bis(2-aminoethyl) ether, 4,7-dioxa-decane-1,10-diamine, 4,9-dioxadodecane-1,12-diamine and higher oligomers thereof, polyoxyalkylenepolyamines having two or three amino groups, obtainable, for example, under the Jeffamine® name (produced by Huntsman Chemicals), aromatic amines, for example 3,5-diethyl-2,4(2,6)-diaminotoluene (Lonzacure DETDA®), 3,5-dimethylthiotolylenediamine (Ethacure 300®), 4,4′-methylenebis(2,6-diethylaniline) (MDEA), 4,4′-methylenebis(3-chloro-2,6-diethylaniline) (MCDEA), and mixtures of the aforementioned polyamines.

Suitable polymercaptans are especially di- or trimercaptans, for example trithioglycerol.

Suitable polyols are especially the following commercially available polyols or mixtures thereof:
polyoxyalkylenepolyols, also known as polyetherpolyols or oligoetherols, which are polymerization products of ethylene oxide, 1,2-propylene oxide, 1,2- or 2,3-butylene oxide, tetrahydrofuran or mixtures thereof, possibly polymerized with the aid of a starter molecule having two or more active hydrogen atoms, for example water, ammonia or compounds having a plurality of OH or NH groups, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the aforementioned compounds. It is possible to use either polyoxyalkylenepolyols which have a low degree of unsaturation (measured according to ASTM D-2849-69 and reported in milliequivalents of unsaturation per gram of polyol (meq/g)), prepared, for example, with the aid of so-called Double Metal Cyanide complex catalysats (DMC catalysts) or polyoxyalkylenepolyols with a higher degree of unsaturation, prepared, for example, with the aid of anionic catalysts such as NaOH, KOH, CsOH or alkali metal alkoxides.

Polyoxyalkylenediols or polyoxyalkylenetriols are particularly suitable, especially polyoxypropylenediols or polyoxypropylenetriols.

Polyoxyalkylenediols or polyoxyalkylenetriols having a degree of unsaturation lower than 0.02 meq/g and having a molecular weight in the range of 1000-30 000 g/mol are especially suitable, as are polyoxypropylenediols and -triols having a molecular weight of 400-8000 g/mol.

Likewise particularly suitable are so-called ethylene oxide-terminated (“EO-endcapped”, ethylene oxide-endcapped) polyoxypropylene-polyols. The latter are specific polyoxypropylenepolyoxyethylenepolyols which are obtained, for example, by further alkoxylating pure polyoxypropylenepolyols, especially polyoxypropylenediols and -triols, with ethylene oxide on completion of the polypropoxylation reaction, and thus have primary hydroxyl groups.

Styrene-acrylonitrile- or acrylonitrile-methyl methacrylate-grafted polyetherpolyols.
Polyesterpolyols, also referred to as oligoesterols, prepared, for example, from di- and trihydric alcohols, for example, 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane or mixtures of the aforementioned alcohols with organic dicarboxylic acids or the anhydrides or esters thereof, for example succinic acid, glutaric acid, adipic acid, suberic acid, sebacic acid, dodecanedicarboxylic acid, maleic acid, fumaric acid, phthalic acid, isophthalic acid, terephthalic acid and hexahydrophthalic acid, or mixtures of the aforementioned acids, and also polyesterpolyols formed from lactones, for example ε-caprolactone.
Polycarbonatepolyols as obtainable by reaction, for example, of the abovementioned alcohols—used to form the polyesterpolyols—with dialkyl carbonates, diaryl carbonates or phosgene.
Polyacrylate- and polymethacrylatepolyols.
Polyhydrocarbonpolyols, also known as oligohydrocarbonols, for example polyhydroxy functional ethylene-propylene, ethylene-butylene or ethylene-propylene-diene copolymers, as produced, for example, by Kraton Polymers, or polyhydroxy functional copolymers of dienes such as 1,3-butadiene or diene mixtures and vinyl monomers such as styrene, acrylonitrile or isobutylene, or polyhydroxy functional polybutadienepolyols, for example those which are prepared by copolymerization of 1,3-butadiene and allyl alcohol and may also be hydrogenated.
Polyhydroxy functional acrylonitrile/butadiene copolymers, as can be prepared, for example, from epoxides or amino alcohols and carboxyl-terminated acrylonitrile/butadiene copolymers (commercially available under the Hycar® CTBN name from Noveon).

These polyols mentioned preferably have a mean molecular weight of 250-30 000 g/mol, especially of 1000-30 000 g/mol, and preferably have a mean OH functionality in the range from 1.6 to 3.
low molecular weight di- or polyhydric alcohols, for example 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, hydrogenated bisphenol A, dimeric fatty alcohols, 1,1,1-trimethylolethane, 1,1,1-trimethylolpropane, glycerol, pentaerythritol, sugar alcohols such as xylitol, sorbitol or mannitol, sugars such as sucrose, other higher polyhydric alcohols, low molecular weight alkoxylation products of the aforementioned di- and polyhydric alcohols, and mixtures of the aforementioned alcohols.

For any polysilane PS, it is advantageous when it a silane equivalent weight of not more than 500 g/eq, especially of 400-100 g/eq, preferably of 350 to 200 g/eq. The silane equivalent weight of the polysilane PS is understood here to mean the molecular weight Mₙ of the polysilane PS divided by the number of silane groups.

The polysilane PS has preferably two to four, preferentially two, silane groups.

Suitable aminosilanes AS which have at least one secondary or tertiary amino group are especially aminosilanes of the formula (V), (VI) or (VII).

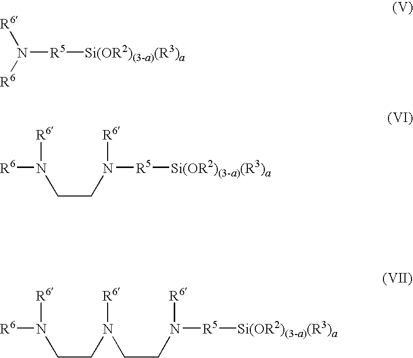

In these formulae, R⁵ is a linear or branched alkylene group having 1 to 6 carbon atoms, especially propylene, R⁶ is an alkyl or cycloalkyl group having 1 to 12 carbon atoms or an aryl group, R^{6′} is a hydrogen atom or an alkyl or cycloalkyl group having 1 to 12 carbon atoms or an aryl group. R^{6′} is preferably H.

The substituents R² and R³ and the index a are each as already defined above.

More particularly, the aminosilane AS which has at least one secondary or tertiary amino group is an aminosilane which is selected from the group consisting of N-methyl-3-aminopropyltrimethoxysilane, N-ethyl-3-aminopropyltrimethoxysilane, N-butyl-3-aminopropyltrimethoxysilane, N-cyclohexyl-3-aminopropyltrimethoxysilane, N-phenyl-3-aminopropyltrimethoxysilane, N-methyl-3-amino-2-methylpropyltrimethoxysilane, N-ethyl-3-amino-2-methylpropyltrimethoxysilane; N-ethyl-3-aminopropyldimethoxymethylsilane, N-phenyl-4-aminobutyltrimethoxysilane, N-phenylaminomethyldimethoxymethylsilane, N-cyclohexylaminomethyldimethoxymethylsilane, N-methylaminomethyldimethoxymethylsilane, N-ethylaminomethyldimethoxymethylsilane, N-propylaminomethyldimethoxymethylsilane, N-butylaminomethyldimethoxymethylsilane; N-(2-aminoethyl)-3-aminopropyltrimethoxysilane, 3-[2(2-aminoethylamino)ethylamino]propyltrimethoxysilane, N-(2-aminoethyl)-3-aminopropylmethyldimethoxysilane and 3-[2-(2-aminoethylamino)ethylamino]-propylmethyldimethoxysilane.

Suitable aminosilanes AS which have at least one secondary or tertiary amino group are, on the other hand, especially addition products of primary amines or secondary amines with epoxysilanes, or of primary or secondary aminosilanes with monoepoxides, especially with monoglycidyl ethers. Such addition products have the structural element of the formula (III) or (III′), especially of the formula (III″) or (III′″).

As aminosilane AS which has at least one secondary or tertiary amino group are additionally products from the Michael-type addition of primary aminosilanes, especially of 3-aminopropyltrimethoxysilane or 3-aminopropyldimethoxymethylsilane, onto Michael acceptors such as acrylonitrile, acrylic and methacrylic esters, maleic and fumaric esters, citraconic esters and itaconic esters, for example dimethyl and diethyl N-(3-trimethoxysilylpropyl)-aminosuccinate. Preference is given to the Michael-type addition products, especially diethyl N-(3-trimethoxysilylpropyl)aminosuccinate.

Most preferred as aminosilanes AS which have at least one secondary or tertiary amino group are compounds of the formula (V) or (VI), especially N-(2-aminoethyl)-3-aminopropyltrimethoxysilane.

The proportion of the polysilane PS is preferably 0.5-15% by weight, especially 1-10% by weight, preferably 1-6% by weight, based on the weight of the adhesive undercoat composition. The proportion of aminosilane AS which has at least one secondary or tertiary amino group is preferably 0.5-25% by weight, especially 1-15% by weight, preferably 2-6% by weight, based on the weight of the adhesive undercoat composition.

The adhesive undercoat composition comprises at least one mercaptosilane MS or an adduct of a mercaptosilane MS. The mercaptosilane MS preferably has the formula (VIII).

HS—R^{4″}—Si(OR^{2″})_{(3-c)}(R^{3″})_{c} (VI)

In this formula, R^{2″} is independently hydrogen or an alkyl group having 1 to 4 carbon atoms or an acyl group, preferably methyl. In addition, R^{3″} is independently H or an alkyl group having 1 to 10 carbon atoms, and R^{4″} is a linear or branched alkylene group having 1 to 6 carbon atoms, especially propylene, and c is 0, 1 or 2, preferably 0.

Especially suitable mercaptosilanes MS are mercaptomethyltrimethoxysilane, mercaptomethyltriethoxysilane, mercaptomethyldimethoxymethylsilane, mercaptomethyldiethoxymethylsilane, 3-mercaptopropyltrimethoxysilane, 3-mercaptopropyltriethoxysilane, 3-mercaptopropyltriisopropoxysilane, 3-mercaptopropylmethoxy(1,2-ethylenedioxy)silane, 3-mercaptopropylmethoxy(1,2-propylenedioxy)silane, 3-mercaptopropylethoxy(1,2-propylenedioxy)silane, 3-mercaptopropyldimethoxymethylsilane, 3-mercaptopropyldiethoxymethylsilane, 3-mercapto-2-methylpropyltrimethoxysilane and 4-mercapto-3,3-dimethylbutyltrimethoxysilane.

Preferred mercaptosilanes MS are 3-mercaptopropyltrimethoxysilane and 3-mercaptopropyltriethoxysilane, especially 3-mercaptopropyltrimethoxysilane.

Suitable adducts of a mercaptosilane MS are especially the addition products of polyisocyanates, especially di- or triisocyanates, of NCO-functional polyol/polyisocyanate adducts, especially with an equivalent weight of less than 1000 g/NCO group, in particular of less than 500 g/NCO group, with diglycidyl ethers or with epoxysilanes.

Preference is given to adhesive undercoat compositions which comprise mercaptosilane MS, especially without the presence of an adduct of a mercaptosilane MS.

The proportion of the mercaptosilane MS is advantageously 0.5-15% by weight, especially 1-10% by weight, preferably 1-6% by weight, based on the weight of the adhesive undercoat composition.

The proportion of the adduct of the mercaptosilane MS is advantageously 0.540% by weight, especially 5-35% by weight, preferably 10-30% by weight, based on the weight of the adhesive undercoat composition.

The adhesive undercoat composition advantageously further comprises at least one organotitanium compound, especially in an amount of 0.1-15% by weight, especially of 0.1-10% by weight, preferably of 1-6% by weight, based on the weight of the adhesive undercoat composition. The organotitanium compound here has at least one substituent bonded to the titanium atom via an oxygen-titanium bond.

Particularly suitable substituents bonded to the titanium atom via an oxygen-titanium bond are those which are selected from the group comprising alkoxy group, sulfonate group, carboxylate group, dialkyl phosphate group, dialkyl pyrophosphate group and acetylacetonate group.

Particularly suitable compounds are those in which all substituents bonded to the titanium are selected from the group comprising alkoxy group, sulfonate group, carboxylate group, dialkyl phosphate group, dialkyl pyrophosphate group and acetylacetonate group, where all substituents may be identical or different from one another.

Particularly suitable alkoxy groups have been found to be especially formula so-called neoalkoxy substituents, especially of the following formula (XI).

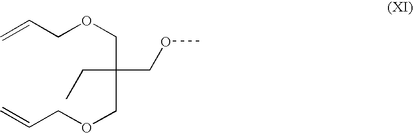

Particularly suitable sulfonic acids have been found to be especially aromatic sulfonic acids whose aromatic rings are substituted by an alkyl group. Preferred sulfonic acids are radicals of the following formula (XII)

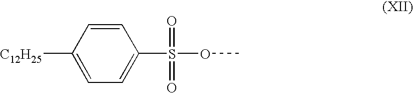

Particularly suitable carboxylate groups have been found to be especially carboxylates of fatty acids. A preferred carboxylate is decanoate.

In the above formulae, the dotted line represents the bond of the oxygen to the titanium.

Organotitanium compounds are commercially available, for example from Kenrich Petrochemicals or DuPont. Examples of suitable organotitanium compounds are, for example, Ken-React® KR TTS, KR 7, KR 9S, KR 12, KR 26S, KR 33DS, KR 38S, KR 39DS, KR44, KR 134S, KR 138S, KR 158FS, KR212, KR 238S, KR 262ES, KR 138D, KR 158D, KR238T, KR 238M, KR238A, KR238J, KR262A, LICA 38J, KR 55, LICA 01, LICA 09, LICA 12, LICA 38, LICA 44, LICA 97, LICA 99, KR OPPR, KR OPP2 from Kenrich Petrochemicals, or Tyzor® ET, TPT, NPT, BTM, AA, AA-75, AA-95, AA-105, TE, ETAM, OGT from DuPont.

Preference is given to Ken-React® KR 7, KR 9S, KR 12, KR 26S, KR 38S, KR44, LICA 09, LICA 44, NZ 44, and Tyzor® ET, TPT, NPT, BTM, AA, AA-75, AA-95, AA-105, TE, ETAM from DuPont.

Particularly preferred organotitanium compounds are those having substituents bonded to the titanium atom via an oxygen-titanium bond of the formulae (XI) and/or (XII).

In addition, the adhesive undercoat composition may, if required, comprise at least one organozirconium compound. An organozirconium compound here has at least one substituent bonded to the zirconium atom via an oxygen-zirconium bond.

Suitable organozirconium compounds are especially those which bear at least one functional group which is selected from the group comprising alkoxy group, sulfonate group, carboxylate group, phosphate or mixtures thereof, and which is bonded directly to a zirconium atom via an oxygen-zirconium bond.

Particularly suitable alkoxy groups have been found to be especially isopropoxy and so-called neoalkoxy substituents, especially of the formula (XI)

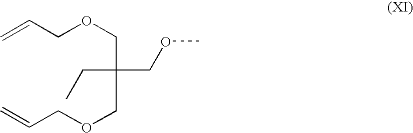

Particularly suitable sulfonic acids have been found to be especially aromatic sulfonic acids whose aromatic rings are substituted by an alkyl group. Preferred sulfonic acids are radicals of the formula (XII)

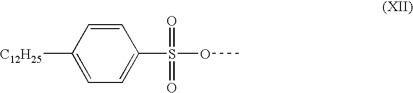

Particularly suitable carboxylate groups have been found to be especially carboxylates of fatty acids. Preferred carboxylates are stearates and isostearates.

In the above formulae, the dotted line represents the bond of the oxygen to the zirconium.

Organozirconium compounds are commercially available, for example from Kenrich Petrochemicals. Examples of suitable organozirconium compounds are, for example, Ken-React® NZ 38J, NZ TPPJ, KZ OPPR, KZ TPP, NZ 01, NZ 09, NZ 12, NZ38, NZ 44, NZ 97.

In addition, the adhesive undercoat composition may comprise further silanes as familiar to the person skilled in the art of adhesive undercoats, especially epoxysilanes, (meth)acrylatosilanes or alklysilanes or vinylsilanes, especially 3-glycidyloxypropyltrimethoxysilane, 3-glycidyloxypropyltriethoxysilane, 3-(meth)acryloxypropyltriethoxysilane, 3-(meth)acryloxypropyl-trimethoxysilane, vinyltrimethoxysilane and vinyltriethoxysilane.

It is clear to the person skilled in the art that these organotitanium compounds and organozirconium compounds hydrolyze under the influence of water and form OH groups bonded to the titanium or zirconium atom. Such hydrolyzed or partly hydrolyzed organotitanium compounds and organozirconium compounds can then condense themselves and form condensation products which have Ti—O—Ti, Zr—O—Zr bonds. When silanes and/or titanates and/or zirconates as adhesion promoters are mixed, mixed condensation products which have Si—O—Ti, Si—O—Zr or Ti—O—Zr bonds are also possible. A small proportion of such condensation products is possible, especially when they are soluble, emulsifiable or dispersible.

The adhesive undercoat composition preferably comprises at least one organotitanium compound.

It has been found to be advantageous when the adhesive undercoat composition comprises a solvent, especially organic solvents. Suitable organic solvents of this kind are especially hydrocarbons, ketones, carboxylic esters or alcohols. Preferred examples thereof are toluene, xylene, hexane, heptane, methyl ethyl ketone, acetone, butyl acetate, ethyl acetate, methanol. Preferred solvents are hydrocarbons, especially toluene and heptane and hexane. In addition, there are also specific embodiments in which water is also suitable as a solvent, but only in a blend with an organic solvent.

The solvent is used especially in an amount of 10-99% by weight, especially of 40-95% by weight, based on the weight of the adhesive undercoat composition.

Under some circumstances, it may be advantageous that the adhesive undercoat composition further comprises polyisocyanates or polyurethane prepolymers having isocyanate groups. Such isocyanates are especially those as have already been described for the preparation of the polysilane PS. Polyurethane prepolymers having isocyanate groups can especially be obtained from the polyisocyanates just mentioned and the polyols and/or polyamines mentioned further down in a known manner.

The adhesive undercoat composition may optionally have further constituents. Further constituents of this kind should, however, not impair the storage stability of the composition. Additional constituents are especially catalysts, stabilizers, surfactants, acids, dyes and pigments.

It has been found to be advantageous that the adhesive undercoat composition is isocyanate-free, i.e. that it does not have any substances with reactive NCO groups.

It has now been found that these adhesive undercoat compositions can be used exceptionally efficiently for production of an adhesive undercoat on a substrate S1, the substrate temperature being low, i.e. lower than 5° C. It has additionally been found that, especially also at substrate temperatures between 0° C. and −20° C., preferably between −5° C. and −15° C., excellent adhesive undercoats can be achieved.

In a further aspect, the invention thus also relates to a process for producing a substrate S1 coated with adhesive undercoat compositions, which comprises the following step:
applying an adhesive undercoat composition as described above to a substrate S1 which has a temperature of less than 5° C., especially of between 0° C. and −20° C., preferably of between −5° C. and −15° C.

Possible substrates S1 are in principle most natural or synthetic substrates. If required, they can be pretreated before the adhesive undercoat compositions are applied. Such pretreatments include especially physical and/or chemical cleaning methods, for example abrading, sandblasting, brushing or the like, or treatment with cleaners or solvents; or the application of an adhesion promoter, of an adhesion promoter solution or of a primer; or flaming or plasma treatment, especially an air plasma pretreatment at atmospheric ambient pressure.

More particularly, the substrate S1 is a mineral substrate, a plastic or a metallic substrate.

A preferred mineral substrate is especially glass or glass ceramic, especially in the form of a pane.

Preferred plastics are especially polyvinyl chloride (PVC), polyurethanes, poly(meth)acrylates, especially in the form of a coating or paint.

A metallic substrate is understood here to mean metals, metal alloys and coated metals and metal alloys. Especially light metals, nonferrous metals and ferrous metals and the alloys thereof are suitable, such as aluminum, iron, copper, zinc, alloys thereof, especially brass and steel.

The adhesive undercoat composition can be applied by means of cloth, felt, roller, spraying, sponge, brush, dipcoating or the like, and can be either manually or by means of robots.

An adhesive can be applied to a substrate coated in this way with adhesive undercoat composition. In a further aspect, the invention therefore relates to a process for adhesive bonding of two substrates S1 and S2. There are different possibilities for this purpose: in a first variant, it comprises the following steps:
a) applying an adhesive undercoat composition as described previously to a first substrate S1 which has a temperature of less than 5° C., especially of between 0° C. and −20° C., preferably of between −5° C. and −15° C.;
b) applying an adhesive to the flashed-off adhesive undercoat composition applied in step a);
c) contacting the adhesive with a second substrate S2.

In a second variant, it comprises the following steps:
a′) applying an adhesive undercoat composition as described above to a first substrate S1 which has a temperature of less than 5° C., especially of between 0° C. and −20° C., preferably of between −5° C. and −15° C.;
b′) applying an adhesive or sealant to the surface of a second substrate S2
c′) contacting the adhesive with the flashed-off composition present on substrate S1.

In a third variant, it comprises the following steps:
a″) applying an adhesive undercoat composition as described above to a first substrate S1 and/or second substrate S2 which has a temperature of less than 5° C., especially of between 0° C. and −20° C., preferably of between −5° C. and −15° C.;
b″) applying an adhesive to the first substrate S1 and second substrate S2, to at least one of which an adhesive undercoat composition has been applied in step a″);
c″) contacting the adhesives applied to one another to join the substrate parts to form an adhesive bond.

In a fourth variant, it comprises the following steps:
a′″) applying an adhesive undercoat composition as described above to a first substrate S1 which has a temperature of less than 5° C., especially of between 0° C. and −20° C., preferably of between −5° C. and −15° C.;
b′″) flashing off the composition
c′″) applying an adhesive between the surfaces of substrates S1 and S2.

In all four of these, the second substrate S2 consists of the same or a different material than substrate S1.

The substrate S1 and/or S2 may be of various kinds. The possibilities for the second substrate S2 may be as described above for the substrate S1. More particularly, at least one of the substrates S1 or S2 is glass or glass ceramic. More particularly, one substrate is glass or glass ceramic and the other substrate is a paint or a painted metal or a painted metal alloy. Therefore, the substrate S1 or S2 is glass or glass ceramic, and the substrate S2 or S1 is a paint or a painted metal or a painted metal alloy.

Step c), c′), c″ or c′″) is typically followed by a step d) of curing the adhesive. The person skilled in the art understands that, according to the system used and reactivity of the adhesive, crosslinking reactions, and hence curing already, can begin as early as during the application. However, the main part of the crosslinking and hence, in the narrower sense of the term, the curing takes place after the application, otherwise problems namely also arise with the buildup of adhesion to the substrate surface.

Usable adhesives are various adhesive systems. More particularly, they are moisture-curing adhesives based on prepolymers terminated with isocyanate groups and/or alkoxysilane.

Suitable adhesives based on alkoxysilane-terminated prepolymers are one-component moisture-curing adhesives, the so-called MS polymers or alkoxysilane-terminated polyurethane prepolymers, especially those as prepared from polyols and isocyanates with subsequent reaction of an isocyanate-reactive organosilane or an isocyanate-functional organosilane.

Suitable adhesives based on isocyanate-terminated prepolymers are understood to mean firstly two-component polyurethane adhesives whose first component comprises an amine or a polyol and whose second component comprises an NCO-containing prepolymer or a polyisocyanate. Examples of such two-component room temperature curing polyurethane adhesives are those from the SikaForce® product line, as commercially available from Sika Schweiz AG.

Suitable adhesives based on isocyanate-terminated prepolymers are additionally understood to mean reactive polyurethane hotmelt adhesives which comprise a thermoplastic polymer and an isocyanate-terminated prepolymer or a thermoplastic isocyanate-terminated prepolymer. Such reactive polyurethane hotmelt substances are melted and firstly solidify in the course of cooling and secondly crosslink through a reaction with air humidity.

Suitable adhesives based on isocyanate-terminated prepolymers are additionally understood to mean one-component moisture-curing polyurethane adhesives. Such adhesives or sealants crosslink under the influence of moisture, especially of air humidity. Examples of such one-component moisture-curing polyurethane adhesives are those from SikaFlex® and SikaTack® product lines, as commercially available from Sika Schweiz AG.

The abovementioned isocyanate-terminated prepolymers are prepared from polyols, especially polyoxyalkylenepolyols, and polyisocyanates, especially diisocyanates.

Preference is given to adhesives based on isocyanate-terminated prepolymers. Most preferred are one-component moisture-curing polyurethane adhesives based on isocyanate-terminated prepolymers.

It has been found that, especially in the case of moisture-curing polyurethane adhesives or sealants, a great improvement in adhesion can be achieved at low temperatures, i.e. especially at a temperature of less than 5° C., especially at a temperature between 0° C. and −20° C., using the composition described. It is obvious that aqueous compositions, owing to ice formation, are likely to be unsuitable for application temperatures of less than 0° C.

These adhesion methods find use especially in the production of articles for industrial manufacture, especially of modes of transport. Such articles are especially automobiles, buses, trucks, rail vehicles, ships or aircraft.

The most preferred application is the glazing of modes of transport, especially of road and rail vehicles.

Owing to the excellent improvement in the adhesion of the adhesives and sealants at low temperatures, this process is suitable especially for glazing repairs. Specifically, it is possible to glaze vehicles on the street on site, especially also in winter, without the vehicle first having to be put into a temperature-controlled garage. This is important in particular for repairs to vehicle panes in remote areas, especially where the roads frequently have loose stones or gravel. Such areas are frequently to be found, for example, in Scandinavia, Russia, China, Argentina, Chile, Canada or the USA. The adhesive undercoat composition is particularly suitable for a process for repairing glazing of a mode of transport, especially of an automobile, at an ambient temperature of less than 5° C., especially of between 0° C. and −20° C., preferably of between −5° C. and −15° C., comprising the steps of
i) removing the defective glass, especially a defective pane;
ii) applying an adhesive undercoat composition as described above to a piece of glass, especially pane, to be inserted by adhesive bonding, and/or to the flange of the mode of transport to be adhesive bonded;
iii) applying a moisture-curing one-component adhesive, especially a moisture-curing one-component polyurethane adhesive, which has a temperature between 10° C. and 80° C., especially about 23° C., to the piece of glass to be adhesive bonded and/or the flange of the mode of transport to be adhesive bonded;
iv) joining glass and flange via the adhesive present between them.

It has been found that, by means of this process, under cold conditions as frequently occur in winter, vehicles can be glazed on the street on site, without the vehicle first having to be put into a temperature-controlled garage. This is important in particular for repairs to vehicle panes in remote areas, especially where the streets frequently have loose stones or gravel. Such areas are frequently to found, for example, in Scandinavia, Russia, China, Argentina, Chile, Canada or the USA.

Since adhesion is also promoted at higher temperatures, i.e. at temperatures of >5° C., typically about room temperature, one and the same adhesive undercoat composition can be used, thus avoiding the necessity of a summer product and of a winter product or of a mode of operation which differs according to the season.

### EXAMPLES

### Preparation of an Illustrative Polysilane

### PS-1

### Corresponding to Formula (X′)

4.61 g of glycerol were initially charged in 100 g of toluene in a stirred vessel, then 20.53 g of 3-isocyanatopropyltrimethoxysilane (Geniosil® GF 40, Wacker) were added with stirring under nitrogen. Subsequently, 0.0125 g of DABCO (1,4-diazabicyclo[2.2.2]octane) was added, the mixture was stirred at 50° C. over 3 hours and left to stand under nitrogen at room temperature over 4 days, another 0.2 g of DABCO was added and the mixture was once again stirred under nitrogen at 70° C. over three days. No free isocyanate groups were detectable any longer by titrimetric means. The mixture was used in the amount specified in Table 1 as PS-1.

### Production of Illustrative Adhesive Undercoat Compositions

The compositions were stirred in a stirred vessel under nitrogen according to the data in Table 1 and introduced into tight-sealing aluminum bottles and used immediately for the adhesion tests.

TABLE 1
Compositions of adhesive undercoat compositions.

| | R1 | R2 | 1 | 2 | 3 |
|---|---|---|---|---|---|
| A1110² [PW]¹ | 3.75 | | | | |
| A1120³ [PW]¹ (AS) | | 3.75 | | | 1.50 |
| A1170⁴ [PW]¹ (PSA) | | | 3.75 | 3.75 | |
| A189⁵ [PW]¹ (MS) | 3.75 | 3.75 | 3.75 | 3.75 | 1.50 |
| PS-1 [PW]¹ (PS) | | | | | 30.00 |
| Tyzor OGT⁶ [PW]¹ | | | | 2.00 | |
| Toluene [PW]¹ | 92.50 | 92.50 | 92.50 | 90.50 | 67.00 |

¹PW = parts by weight
²A1110 = Silquest ® A1110, GE Silicones, Switzerland, 3-aminopropyltrimethoxysilane
³A1120 = Silquest ® A1120, GE Silicones, Switzerland N-(2-aminoethyl)-3-aminopropyltrimethoxysilane,
⁴A1170 = Silquest ® A1170, GE Silicones, Switzerland, bis(trimethoxysilylpropyl)amine
⁵A189 = Silquest ® A189, GE Silicones, Switzerland, 3-mercaptopropyltrimethoxysilane
⁶Tyzor ® OGT, DuPont, octylene glycol titanate = tetrakis(2-ethylhexane-1,3-diolato)titanate

The adhesive undercoat compositions were applied (wipe-on) by means of a lint-free Kleenex® tissue soaked with the composition at the application temperature (“Tₐₚₚ”) of 23° C. or −10° C., excess composition was immediately wiped off with a dry cellulose cloth, and the compositions were flashed off during the flashoff time of 10 minutes (“t_{FO}”).

The following substrates were used
Float glass Rocholl, Germany, applied to tin side (“glas_{Sn}”)
Float glass Rocholl, Germany, applied to air side (“glass_{Air}”)
VSG ceramic Rocholl, Germany, No. 14279 (“VSG”)
ESG ceramic Rocholl, Germany, No. 14251 (“ESG”)
Glass ceramic Windshield of a BMW 316/328/M3 Limousine+Touring (Pilkington) (“BMW”)
Glass ceramic Windshield of a Mazda 323 Coupe F51 (BG) (Pilkington) (“Mazda”)
Glass ceramic Windshield of a Honda Integra Type L Coupe 1998 (Swiss Lamex) (“Honda”)
Glass ceramic Windshield of a VW Transporter T4 1990/98 (GT Safety)(“VW”)

Both the compositions and the substrates were conditioned at the application temperature over at least 12 hours.

On expiry of the flashoff time, in a room at −10° C. or 23° C., SikaTack®-Move Goes Cool (commercially available from Sika Schweiz AG) (adhesive temperature 23° C.) was applied as a triangular bead (base 12 mm, height 8 mm) and pressed to a layer thickness of 4 mm by means of baking paper.

Before conditioning, all substrates were wiped with an isopropanol-soaked cellulose cloth and flashed off over 10 minutes.

The adhesive was tested after a curing time of 7 days of storage in a climate-controlled room (‘CC’) (23° C., 50% rel. air humidity), and after a subsequent water storage (‘WS’) in water at 23° C. over 7 days, and after a subsequent storage under hot and humid conditions (‘HH’) at 70° C. for 7 days, 100% rel. air humidity.

The adhesion of the adhesive was tested by means of a ‘bead test’. In this test, the bead is incised at the end just above the adhesive surface. The incised end of the bead is held with round-end tweezers and pulled from the substrate. This is done by carefully rolling up the bead onto the tip of the tweezers, and placing a cut at right angles to the bead pulling direction down to the bare substrate. The bead pulling speed should be selected such that a cut has to be made about every 3 seconds. The test distance must be at least 8 cm. After the bead has been pulled off, the adhesive remaining on the substrate is assessed (cohesion fracture). The adhesion properties are assessed through visual determination of the cohesive component of the adhesive surface:

The higher the component of cohesive fracture, the better the adhesive bond is considered to be. Test results with cohesion fractures of less than 50%, especially less than 40%, are typically considered to be unsatisfactory.

The adhesion results are listed in Tables 2 and 3.

Reference Examples R1 and R2 correspond to Example 1, in which the polysilane with a secondary amino group (A1170) has been replaced, respectively, by a primary aminosilane (A1110) and by a monosilane with primary and secondary amino groups (A1120). Example 3 is an example which has a combination of a polysilane (PS-1) and of a silane with a secondary amino group (A1120).

The results show that Examples 1, 2 and 3 have improved adhesion, especially at low temperatures, i.e. at −10° C.

TABLE 2
Adhesion results on different substrates at different application temperatures.

| | | Glass_{Sn} | | | Glass_{Air} | | | VSG | | | ESG | | |
|---|---|---|---|---|---|---|---|---|---|---|---|---|---|
| | Tₐₚₚ | CC | WS | HH | CC | WS | HH | CC | WS | HH | RT | WS | HH |
| R1 | −10° C. | 5 | 0 | 30 | 95 | 90 | 50 | 100 | 0 | 10 | 100 | 0 | 10 |
| R2 | −10° C. | 80 | 70 | 100 | 100 | 100 | 40 | 95 | 25 | 50 | 100 | 10 | 5 |
| 1 | −10° C. | 60 | 10 | 80 | 100 | 100 | 30 | 100 | 100 | 100 | 100 | 100 | 100 |
| 2 | −10° C. | 20 | 20 | 100 | 100 | 100 | 50 | 100 | 100 | 100 | 100 | 100 | 100 |
| 3 | −10° C. | 30 | 5 | 95 | 95 | 80 | 10 | 100 | 75 | 100 | 100 | 100 | 100 |
| R1 | 23° C. | 95 | 30 | 80 | 100 | 30 | 10 | 100 | 0 | 20 | 100 | 0 | 0 |
| R2 | 23° C. | 100 | 30 | 85 | 100 | 80 | 80 | 100 | 0 | 5 | 100 | 0 | 0 |
| 1 | 23° C. | 0 | 0 | 100 | 100 | 90 | 5 | 100 | 100 | 100 | 100 | 100 | 100 |
| 2 | 23° C. | 95 | 50 | 100 | 100 | 100 | 10 | 100 | 100 | 100 | 100 | 100 | 100 |
| 3 | 23° C. | 50 | 30 | 100 | 100 | 95 | 0 | 100 | 25 | 100 | 100 | 10 | 100 |

TABLE 3
Adhesion results to different original glass ceramics at different application temperatures.

| | | BMW | | | Mazda | | | Honda | | | VW | | |
|---|---|---|---|---|---|---|---|---|---|---|---|---|---|
| | Tₐₚₚ | CC | WS | HH | CC | WS | HH | CC | WS | HH | RT | WS | HH |
| R1 | −10° C. | 100 | 5 | 100 | 80 | 0 | 40 | 100 | 30 | 90 | 100 | 0 | 70 |
| R2 | −10° C. | 95 | 50 | 90 | 100 | 95 | 100 | 95 | 100 | 100 | 100 | 10 | 90 |
| 1 | −10° C. | 100 | 100 | 95 | 100 | 100 | 100 | 100 | 100 | 100 | 100 | 100 | 100 |
| 2 | −10° C. | 100 | 100 | 100 | 100 | 100 | 70 | 100 | 100 | 95 | 100 | 100 | 100 |
| 3 | −10° C. | 100 | 100 | 100 | 50 | 50 | 50 | 100 | 100 | 100 | 95 | 100 | 100 |
| R1 | 23° C. | 100 | 0 | 20 | 100 | 0 | 0 | 100 | 10 | 20 | 100 | 5 | 40 |
| R2 | 23° C. | 100 | 20 | 50 | 95 | 0 | 0 | 100 | 30 | 50 | 100 | 5 | 60 |
| 1 | 23° C. | 100 | 90 | 100 | 100 | 100 | 100 | 100 | 30 | 95 | 100 | 5 | 100 |
| 2 | 23° C. | 100 | 100 | 100 | 100 | 100 | 100 | 100 | 100 | 100 | 100 | 100 | 100 |
| 3 | 23° C. | 100 | 100 | 100 | 85 | 10 | 75 | 90 | 50 | 60 | 70 | 10 | 50 |

1. A method for producing a substrate S1 coated with an adhesive undercoat composition,
comprising applying an adhesive undercoat composition on a substrate S1 at a substrate temperature of less than 5° C. wherein the adhesive undercoat composition comprises:
at least one mercaptosilane MS or an adduct of a mercaptosilane MS;
either at least one polysilane PSA which has at least one secondary or tertiary amino group or at least one polysilane PS; and
at least one aminosilane AS which has at least one secondary or tertiary amino group.

2. The method as claimed in claim 1, wherein the polysilane PSA which has at least one secondary or tertiary amino group is an aminosilane of the formula (I) 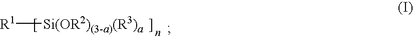
where R¹ is an n-valent organic radical having at least one secondary or tertiary amino group,
R² is independently hydrogen or an alkyl group having 1 to 4 carbon atoms or an acyl group;
R³ is independently H or an alkyl group having 1 to 10 carbon atoms;
a is 0, 1 or 2;
and n is 2, 3 or 4.

3. The method as claimed in claim 2, wherein the polysilane PSA which has at least one secondary or tertiary amino group is an aminosilane of the formula (II) 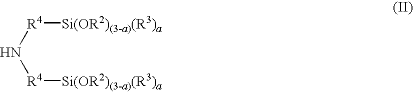
where R⁴ is a linear or branched alkylene group having 1 to 6 carbon atoms, especially propylene.

4. The method as claimed in claim 2, wherein the polysilane PSA which has at least one secondary or tertiary amino group has at least one structural element of the formula (III) (III′) (III″) or (III′″)

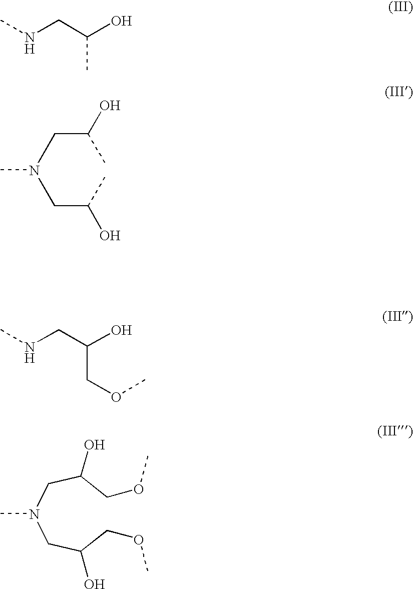

5. The method as claimed in claim 4, wherein the polysilane PSA which has at least one secondary or tertiary amino group is a reaction product of an epoxysilane of the formula (IV) with an aminosilane of the formula (IV′) 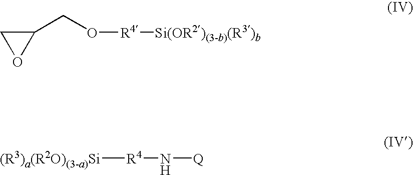
where
R^{2′} is independently hydrogen or an alkyl group having 1 to 4 carbon atoms or an acyl group having 1 to 4 carbon atoms;
R^{3′} is independently H or an alkyl group having 1 to 10 carbon atoms;
R⁴ and R^{4′} are each independently a linear or branched alkylene group having 1 to 6 carbon atoms;
Q is H, a C₁-C₂₀-alkyl, cycloalkyl or aryl radical, or a radical of the formula —(CH₂—CH₂—NH)_{d}H or a radical of the formula —R⁴—Si(OR²)₍₃₋ₐ₎(R³)ₐ,
and b and d are each 0, 1 or 2.

6. The method as claimed in claim 1, wherein the polysilane PS has a silane equivalent weight of not more than 500 g/eq.

7. The method according to claim 1, wherein the polysilane PS contains two to four silane groups.

8. The method according to claim 1, wherein an aminosilane AS which has at least one secondary or tertiary amino group has the formula (V), (VI) or (VII) 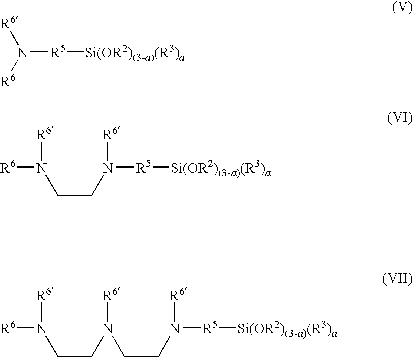
where R⁵ is a linear or branched alkylene group having 1 to 6 carbon atoms;
R⁶ is an alkyl or cycloalkyl group having 1 to 12 carbon atoms or an aryl group and
R^{6′} is a hydrogen atom or an alkyl or cycloalkyl group having 1 to 12 carbon atoms or an aryl group.

9. The method as claimed in claim 1, wherein the mercaptosilane MS has the formula (VIII)
HS—R^{4″}—Si(OR^{2″})_{(3-c)}(R^{3″})_{c} (VIII)
where R^{2″} is independently hydrogen or an alkyl group having 1 to 4 carbon atoms or an acyl group;
R^{3″} is independently H or an alkyl group having 1 to 10 carbon atoms;
R^{4″} is a linear or branched alkylene group having 1 to 6 carbon atoms;
and c is 0, 1 or 2.

10. The method as claimed in claim 1, wherein the adhesive undercoat composition further comprises at least one organotitanium compound in an amount of 0.1-15% by weight, based on the weight of the adhesive undercoat composition.

11. The method as claimed in claim 1, wherein the adhesive undercoat composition further comprises a solvent in an amount of 10-99% by weight, based on the weight of the adhesive undercoat composition.

12. The method as claimed in claim 1, wherein the proportion of the mercaptosilane MS is 0.5-15% by weight, based on the weight of the adhesive undercoat composition.

13. The method as claimed in claim 1, characterized in that the proportion of the polysilane PSA which has at least one secondary or tertiary amino group is 0.5-30% by weight, based on the weight of the adhesive undercoat composition.

14. The method as claimed in claim 1, wherein the proportion of the polysilane PS is 0.5-15% by weight, based on the weight of the adhesive undercoat composition.

15. The method as claimed in claim 14, wherein the proportion of aminosilane AS which has at least one secondary or tertiary amino group is 0.5-25% by weight, based on the weight of the adhesive undercoat composition.

16. (canceled)

17. A process for adhesive bonding two substrates S1 and S2, which has at least the following steps
a) applying an adhesive undercoat composition as described in claim 1 to a first substrate S1 which has a temperature of less than 5° C.;
b) applying an adhesive to the flashed-off adhesive undercoat composition applied in step a);
c) contacting the adhesive with a second substrate S2;
or
a′) applying an adhesive undercoat composition—as described in claim 1 to a first substrate S1 which has a temperature of less than 5° C.;
b′) applying an adhesive or sealant to the surface of a second substrate S2
c′) contacting the adhesive with the flashed-off composition present on substrate S1;
or
a″) applying an adhesive undercoat composition as described in claim 1 to a first substrate S1 and/or second substrate S2 which has a temperature of less than 5° C.;
b″) applying an adhesive to the first substrate S1 and second substrate S2, to at least one of which an adhesive undercoat composition has been applied in step a″);
c″) contacting the adhesives applied to one another to join the substrate parts to form an adhesive bond;
or
a′″) applying an adhesive undercoat composition as described in claim 1 to a first substrate S1 which has a temperature of less than 5° C.;
b′″) flashing off the composition
c′″) applying an adhesive between the surfaces of substrates S1 and S2, the second substrate S2 consisting of the same material or a different material than substrate S1.

18. The process as claimed in claim 17, wherein step c) or c′) or c″) or c′″) is followed by a step d) for curing the adhesive.

19. The process as claimed in claim 17, wherein at least one of the substrates S1 or S2 is glass or glass ceramic.

20. The process as claimed in claim 17, wherein the substrate S1 or S2 is glass or glass ceramic, and in that the substrate S2 or S1 is a paint system or a painted metal or a painted metal alloy.

21. An article produced by performing a process as claimed in claim 17.

22. An article as claimed in claim 21, wherein the article is a means of transport.

23. A process for repairing glazing of a means of transport at an ambient temperature of less than 5° C., comprising the steps of
i) removing the defective glass, especially a defective pane;
ii) applying an adhesive undercoat composition as described in claim 1 to a piece of glass, to be inserted by adhesive bonding, and/or to the flange of the mode of transport to be adhesive bonded;
iii) applying a moisture-curing one-component adhesive, especially a moisture-curing one-component polyurethane adhesive, which has a temperature between 10° C. and 80° C., to the piece of glass to be adhesive bonded and/or the flange of the mode of transport to be adhesive bonded;
iv) joining glass and flange via the adhesive present between them.
